(19) United States
(12) Patent Application Publication
(10) Pub. No.: US 2009/0211468 A1
(43) Pub. Date: Aug. 27, 2009

(54) METHOD FOR DISPOSING OF USED EMBOSSING FOIL WEBS AND EMBOSSING APPARATUS WITH CONTINUOUSLY OPERATING DISPOSAL DEVICE

(75) Inventor: Marc Steuer, Waldenbuch (DE)

Correspondence Address: AKERMAN SENTERFITT, P.O. BOX 3188, WEST PALM BEACH, FL, 33402-3188, US

(73) Assignee: SPM Steuer GMBH & Co. KG, Leinfelden-Echterdingen (DE)

(21) Appl. No.: 12/388,332

(22) Filed: Feb. 18, 2009

(30) Foreign Application Priority Data
Feb. 20, 2008 (DE) 102008011493.6

(51) Int. Cl. B41F 19/02; B31F 1/07

(52) U.S. Cl. 101/23; 101/32

(57) ABSTRACT

In a method for disposing of used embossing foil webs during the operation of an embossing apparatus, in which at least one embossing foil web is moved with the aid of a foil feed device with varying web speeds through an embossing gap and is subsequently supplied to a disposal device, the embossing foil web is removed from a final control device of the foil feed device by means of a tension conveying device downstream of the foil feed device and which produces a tension acting on the embossing foil web independently of the direction and amount of the embossing foil web speed in the same tension direction, as well as a cutting through of the embossing foil web in predeterminable time sections downstream of the tension conveying device outside an engagement area of the tension conveying device for producing cut off embossing foil web portions. The latter can then be disposed of. An embossing apparatus equipped with a corresponding disposal device is described.

### BACKGROUND OF THE INVENTION

1. Field of the Invention

The invention relates to a method for disposing of used embossing or stamping foil webs in connection with the operation of an embossing or stamping apparatus. The invention further relates to an embossing or stamping apparatus set up for performing the method, and to a disposal device.

2. Description of the Related Art

For hot embossing or stamping in a hot embossing or stamping apparatus a material layer to be embossed or stamped, e.g. a printing material sheet or a printing material web, is guided through an embossing or stamping gap which is formed between an embossing tool carrier device and a back pressure element, e.g. a back pressure cylinder. The embossing tool carrier device carries one or more embossing tools, which can be heated by means of a heating device during hot embossing. As a function of the embossing apparatus type, the embossing tool carrier device can e.g. have a flat shape in the case of so-called round-flat machines, or a cylindrical shape in the case of so-called round-round machines or rotary machines. During the operation of the embossing apparatus at least one embossing foil web is moved with the aid of a foil feed mechanism with a web speed predeterminable by the foil feed device control unit through the embossing gap in such a way that during an embossing interval it is moved at the same speed as the material layer to be embossed through the embossing gap. During the embossing interval, to the embossing material located on the embossing foil web transfer takes place of e.g. discreet successively positioned embossing units such as images, texts and/or holograms, or part of an ink or metal coating to be embossed, under the action of pressure and temperature on the material layer. The embossing foil web is removed by the foil feed device from a normally roll-like foil supply and moved through the embossing gap, the used embossing foil is led away and has to be disposed of.

Generally successive embossing locations on the printing material have a certain distance from one another. As it would be uneconomic to keep the corresponding embossing units or ink coating areas in equidistant manner on the embossing foil web, for optimizing foil consumption the aim is to bring closer together the successive ink coating areas to be embossed or the successive embossing units on the embossing foil web closer together than the successively positioned embossing locations on the printing material. This objective is achieved in that outside the embossing interval the embossing foil web is moved more slowly than the material layer to be embossed, is sped up prior to the embossing interval to the material layer speed and is then slowed down again and optionally removed counter to the main feed direction.

EP 718 099 B1 e.g. discloses a rotary embossing machine with a foil feed device allowing such successive acceleration, synchronous, deceleration and withdrawal phases of the embossing foil web with mechanical loading of the generally very thin and therefore sensitive embossing foil web kept to a minimum. In the case of this hot embossing apparatus disposal takes place by the used embossing foil web being wound onto a continuously rotating wind-up storage roll. Between the last control devices of the foil feed device actively participating in the control of the foil web speed and the wind-up roll fitting takes place of a foil loop storage means, which allows the transfer between the discontinuous foil web movement in the vicinity of the embossing gap and the continuous winding up movement at the wind-up roll. The wind-up roll must every so often be replaced by an empty roll, which leads to undesired machine stoppage times.

EP 989 086 B1 discloses a hot embossing machine with a continuously operating disposal device, which has a feed roller in the form of a suction roller by means of which the embossing foil web is passed over a certain looping angle, together with a mechanical cutting mechanism cooperating with the feed roller for cutting through the foil web portion retained on the feed roller circumference by means of a cutting knife. As the embossing foil web is held on the feed roller circumference on either side of the cutting point, it is possible to reduce an undesired reaction of the mechanical cutting process on the foil feed through the embossing gap. The cut off web portions are sucked off by means of a suction device following on to the feed roller and are disposed of.

In the case of the embossing apparatus of DE 10 2005 003 787 A1 the embossing foil web for disposal is introduced by means of a slip drive belonging to the foil feed device into a storage chamber, where it forms suspended or depositing loops constituting a reservoir for a discontinuous or alternating operation of the embossing apparatus. The loops or packages can be individually cut off in the disposal device or this can take place at the storage chamber outlet, accompanied by the formation of rolls.

An embossing apparatus known from GB 2 254 586 has on the waste side a disposal device functioning in the manner of a shredder to which the used web material is supplied with the aid of an upstream delivery station. The latter has two oppositely rotating feed rollers between which the web material is jammed and conveyed through. The delivery station serves as an intermittently functioning pull or tension device for foil feed, which admittedly takes place discontinuously with varying speed, but without any retraction phases and always in the delivery station direction.

### SUMMARY OF THE INVENTION

It is one object of the invention is to provide a method for disposing of used embossing foil webs and an embossing apparatus with continuously operating disposal device, which ensure a rapid, troublefree disposal of used embossing foil webs, particularly in the case of a discontinuous foil feed with successive acceleration, synchronous, deceleration and withdrawal phases of the embossing foil webs. Foil disposal should take place without any disadvantageous reactions on the controlled foil movement through the embossing gap.

According to one formulation of the invention these and other objects are achieved by a method for disposing of used embossing foil web during the operation of an embossing apparatus, in which method at least one embossing foil web is moved with the aid of a foil feed device with varying web speed through an embossing gap and is then supplied to a disposal device, the method comprising: removing the embossing foil web from a final control device of the foil feed device by means of a tension conveying device positioned downstream of the foil feed device, wherein the tension conveying device produces a tension acting on the embossing foil web in the same tension direction independently of the direction and value of the embossing foil web speed;

cutting through the embossing foil web in predeterminable time sections downstream of the tension conveying device outside an engagement area of said tension conveying device for producing cut off embossing foil web portions; and
disposing of the cut off embossing foil web portions. Advantageous further developments are given in the dependent claims. By express reference the wording of all the claims is made into part of the content of the description.

In the case of a method according to the invention the embossing foil web is drawn off a final control device of the foil feed device by means of a pull or tension conveying device downstream of the foil feed device and which is designed for producing a pull or tension on the embossing foil web independently of the direction and value of the embossing foil web speed in the same pull or tension direction, as well as a cutting through of the embossing foil web in predeterminable time sections downstream of the tension conveying device outside an engagement area thereof for producing cut off embossing foil web portions, which can then be disposed of.

The foil feed device, which is also referred to hereinafter as the “foil mechanism”, has one or more control devices participating actively in the control of the foil web movement, in order to accurately determine the embossing foil web speed in the embossing gap with regards to value and optionally direction in accordance with a control program. The control devices can e.g. include so-called timing rollers (or control rollers), which are in non-slip rolling contact with the embossing foil web and are precisely controllable with regards to rotation speed and direction. Particularly in the case of foil mechanisms which are designed for phasewise foil return feed counter to the main feed direction, it is also possible to use control devices with a slip drive. In addition to the active control devices the foil mechanism generally has several passive guide devices, e.g. guide rollers and/or air deflection bars, in order to establish the course of the embossing foil web or webs through the foil mechanism.

The tension conveying device is separate from the foil feed device elements and whose essential function is to reliably detect the at least one embossing foil web passing out of the foil feed device with a varying speed and to exert tension on the embossing foil web in such a way that after said web passes out of the foil feed device it still has a certain residual web tension and can therefore be conveyed away in orderly manner from the foil feed device. To this end the tension conveying device can be designed in such a way that the continuously or uninterruptedly acting tension is at all times lower than the tensions acting on the embossing foil web within the foil feed device and which are competent for defining the web speed and position within the foil feed device. Independently of the web speed direction and value, the tension conveying device tension always acts in the direction of a drawing off of the embossing foil web from the final control device of the foil feed device in order to ensure an orderly drawing off of the embossing foil web without any significant reaction on the foil feed within the foil feed device. In order to produce the tension the tension conveying device acts on the embossing foil web over an engagement area extended to a varying degree in the web direction.

Downstream of the engagement area, i.e. on the tension conveying device side remote from the foil mechanism, the embossing foil web is cut through by means of a cutting device in time intervals defined by measurement and/or control or in some other way, so that cut off embossing foil web portions are obtained and whose length is essentially defined by the ratio between the global feed speed of the embossing foil web in the disposal side direction and the length of the time intervals between the cutting through steps and can correspondingly be adjusted. These embossing foil web portions can be disposed of in different ways.

In some method variants the embossing foil web is retracted by a given retraction distance in phasewise manner counter to the main feed direction and therefore counter to the action direction of the tension applied through the tension conveying device and as a result foil consumption can be minimized. In such cases the length of the engagement area of the tension conveying device exceeds the value of the maximum retraction distance of the embossing foil web. Thus, a reliable tension conveying of the embossing foil web is still ensured if the cutting through of the embossing foil web takes place spatially directly following the exit of the web from the tension conveying device.

In some embodiments the embossing foil web is conveyed substantially in contactfree manner in the tension direction within the tension conveying device by means of a directional gas flow, particularly an air flow. As a result of the pneumatic force introduction a particularly gentle, protective tension conveying of the embossing foil web is made possible and there is a reliable avoidance of drag on the said web, which could possibly have a negative reaction on the critical web feed within the foil mechanism.

In some embodiments the embossing foil web in the tension conveying device and accompanied by the production of sliding friction is pressed onto a planar or curved conveying surface moving in the tension direction. Such variants can also be referred to as “slip drive”, because the conveying surface at least temporarily, but preferably throughout the entire conveying time is moved with a speed excess compared with the embossing foil web in the tension direction, so that static friction phases can be avoided. This also leads to a gentle, peak-free tension on the embossing foil web, so that there is no detectable reaction on the controlled foil advance or retraction in the foil mechanism.

Different embodiments of fundamentally suitable slip drives are e.g. known from EP 718 099 B1 and are consequently not described in greater detail here. Whereas in the prior art slip drives are used as active control devices within the framework of the control of the foil movement through the embossing gap, in the systems according to the invention use is made outside the foil mechanism competent for the defined foil feed and the forces acting from the slip drive on the embossing foil web can generally be much lower than when used within the framework of foil feed devices.

In some embodiments the tension conveying device contains at least one conveying brush engaging on the embossing foil web and whose bristles, on rotating said conveying brush, transfer a tension contribution to the said embossing foil web. One or more conveying brushes can be provided in addition to other conveying means, e.g. in addition to a slip drive, within the scope of the tension conveying device. It is also possible to design the tension conveying device as a brush conveyor, in which all the tension acting on the embossing foil web is transferred with the aid of conveying brushes by means of mechanism contact, but in a very gentle manner to the used embossing foil web. The embossing conveying device can also be constructed in the manner of a bar chain conveyor or the latter can be provided in addition to some other conveying principle.

The cutting through of the embossing foil web following release from the engagement areas of the tension conveying device can take place mechanically, e.g. with the aid of a cutting knife pressed cyclically against an opposing element. A shearing cutting through by means of cutting shears or the like is also possible. However, in preferred variants use is made of a contactless operating cutting apparatus, so that the embossing foil web is cut through in contactless manner, i.e. without mechanical contact between said web and an element of the cutting apparatus. Thus, during the cutting process no mechanism force is exerted on the embossing foil web, so that the conveying of said web through the tension conveying device is not influenced by the cutting process. Obviously, as a result there is no need to fear any reaction of the cutting process on the web feed through the embossing gap.

In some variants the embossing foil web is melted along a cutting line running transversely to the web direction with the aid of a locally concentrated thermal action, which with the generally relatively thin embossing foil webs with plastic carrier foils is possible rapidly and making use of relatively small thermal energy quantities. In some embodiments at least one laser is used for cutting through the embossing foil web and its laser beam is e.g. guided by the movement of the laser and/or by a movable deflection means in the manner of a scanner along the cutting line. For cutting through the embossing foil web it is also possible to use a hot gas jet device, which e.g. produces a wider “hot gas meter” or a correspondingly finally focussed hot gas jet, which is moved transversely over the embossing foil web. There are other possibilities for cutting through the embossing foil web in contactless manner with the aid of a jet tool, e.g. with the aid of a suitably fine and therefore “sharp” liquid jet. As an alternative to contactless thermal cutting through it is also possible to have a thermal cutting through by means of a heating wire heatable electrically or in some other way, which in the case of brief contact with the embossing foil web introduces the thermal energy necessary for web melting along the cutting line.

For disposing of the cut off embossing foil web portions numerous appropriate methods and devices can be used. For some embodiments the cut off embossing foil web portions are initially guided by means of a suction device into a collecting device, which can then be replaced every so often, even during embossing apparatus operation. Use can also be made of a shredder or some other device for comminuting the cut off embossing foil web portions into smaller and possibly more easily disposable particles. Alternatively or additionally use can be made of a baling press or some other device for compressing complete embossing foil web portions (or commination products therefrom) in order to give small volume waste packages. The waste products (embossing foil web portions or parts thereof) from one or more embossing apparatuses can also be disposed of by means of a central suction plant.

An embossing apparatus suitable for performing the method has an embossing mechanism, where between an embossing tool carrier device and a back pressure element is formed at least temporarily an embossing gap, and a foil feed device for the feeding of at least one embossing foil web through the embossing gap with varying web speed, as well as a disposal device downstream of the foil feed device for disposing of used embossing foil webs. The disposal device comprises a tension conveying device downstream of the foil feed device for removing the at least one embossing foil web from a final control device of the foil feed device, as well as a cutting device downstream of the tension conveying device for cutting through the embossing foil web in predeterminable time sections outside an engagement area of the tension conveying device. The cutting device is generally followed by a disposal unit for disposing of the cut off embossing foil web portions.

The invention also relates to a corresponding disposal device, which can be assembled as a separate unit and is to be positioned downstream of the final control device of the foil feed device of an embossing apparatus in order to remove used embossing foil web in orderly manner from the final control device.

These and further features can be gathered from the claims, description and drawings and the individual features, in each case singly or in the form of subcombinations, can be implemented in an embodiment of the invention and in other fields and can represent advantageous, independently protectable constructions. Embodiments of the invention are described hereinafter relative to the drawings, wherein show:

### BRIEF DESCRIPTION OF THE DRAWINGS

FIG. 1 Diagrammatically a round-flat embossing apparatus for the hot embossing of material sheets.

FIG. 2 Diagrammatically a contactless operating pneumatic tension conveying device.

FIG. 3 Diagrammatically a tension conveying device with a suction conveyor belt.

FIG. 4 Diagrammatically a tension conveying device with a suction roller.

FIG. 5 Diagrammatically a tension conveying device with a suction roller and downstream conveying brushes.

FIG. 6 Diagrammatically a tension conveying device with several pairs of conveying brushes.

FIG. 7 Diagrammatically an embodiment of a cutting device with a laser displaceable transversely to the web direction.

FIG. 8 An embodiment of a cutting device with a pivotable hot gas jet generator.

FIG. 9 Diagrammatically a cutting device with an electrically heatable heating wire.

### DETAILED DESCRIPTION OF THE PREFERRED EMBODIMENTS

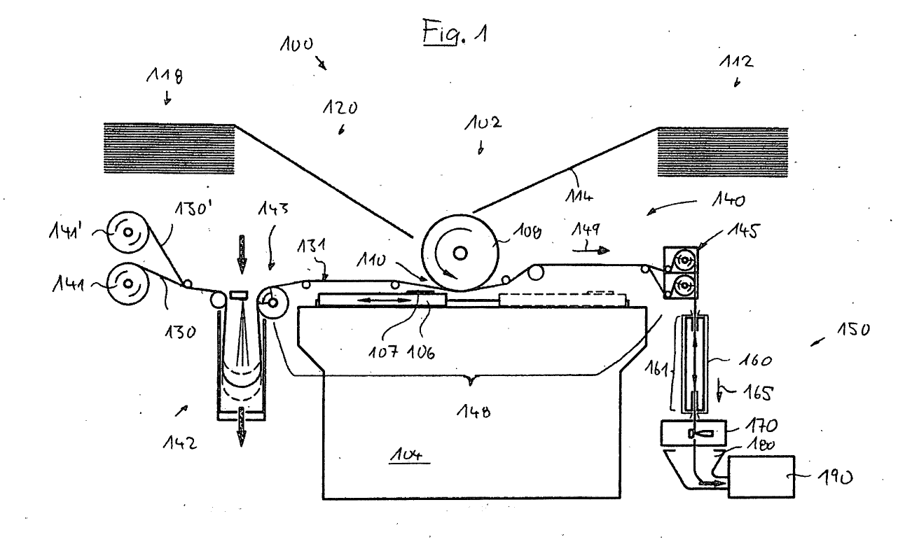

FIG. 1 is a diagrammatic side view of an embodiment of an embossing apparatus 100 in the form of a round-flat machine and which is set up for embossing sheet-like printing material formed by paper, cardboard, plastic and/or some other flexible flat material by means of hot embossing. The embossing apparatus 100, also known as a hot embossing apparatus, has an embossing mechanism 102, which comprises an embossing tool carrier device 106 horizontally movably guided on the embossing apparatus bed 104 and a back pressure cylinder 108 provided with a horizontal rotation axis above the machine bed 104 and between which is temporarily formed during the operation of the apparatus an embossing gap 110 when the embossing tool carrier device 106 is in the area below the back pressure cylinder. The embossing tool carrier device 106 is horizontally moved backwards and forwards along straightline paths by a not shown drive and is intended to carry on its top side facing the back pressure cylinder replaceable embossing tools or types 107, which can be heated to temperatures above 100° C. by means of an integrated electrical heating device.

The material sheet to be printed is held with the side to be printed upwards on a stock or storage pile 112 and during the operation of the embossing apparatus is supplied by means of a sloping feed table 114 to the back pressure cylinder 108 of the embossing tool in a scale-like arrangement. The back pressure cylinder circumference carries gripper systems installed for in each case gripping a leading edge of a sheet and drawing it onto the circumferential surface of the uniformly rotating back pressure cylinder. During the gripping process there is an orientation of the printing material sheet, e.g. relative to the leading edge or specific image layers. The printing material sheet hanging with a leading edge on the back pressure cylinder circumference is guided in the rotation direction shown from left to right through the embossing gap and is embossed in a manner to be described hereinafter. Following the embossing interval the embossed material sheet is transferred to the left-hand discharge system 120 extending with a sloping conveying device to the back pressure cylinder circumference and comprising a gripper system, bands or the like, which deliver the printing material sheets in successive manner to the delivery pile 118. The discharge system is in other embodiments on the same side of the embossing mechanism as the feed system.

On passage through the embossing gap (from left to right in the drawing) the material sheet surface to be printed has a speed which, as a function of the thickness of the printed sheet, essentially corresponds to the circumferential speed of the circumferential surface of the continuously rotating back pressure cylinder.

During embossing apparatus operation at least one embossing foil web 130, 130′ is moved with the aid of a foil feed device 140 with a varying web speed precisely predeterminable by the action of active control devices of the foil feed device through the embossing gap 110. The very thin embossing foil web, whose typical thickness is e.g. between 10 and 20 æm, is generally constituted by a relatively tough plastic carrier film, on whose front side 131 is applied a layer system with a thermally activatable separating layer, the actual embossing layer (e.g. ink layer, metal layer, hologram, image, etc.) and a thermally activatable hot melt adhesive layer forming the front side of the embossing foil web.

The embossing foil web speed is so controlled by control-active control devices of the foil feed device that during a given embossing interval, they run at the same speed as regards value and direction as the material layer to be printed through the embossing gap 110. Simultaneously the linearly displaceable embossing tool carrier device 106 is so accelerated from its left-hand starting position shown in the direction of the back pressure cylinder that during the embossing interval the embossing tools 107 also have the same speed as the material layer to be embossed and the embossing foil web guided between the material layer and embossing tool. Thus, under the influence of pressure and temperature, during the embossing interval, the embossing unit is transferred to the material layer to be embossed. Since during the inward passage the tool carrier device was moved during the embossing interval in synchronous manner with the material layer and the embossing foil web, at the end of the embossing interval it is decelerated until it reaches the stop position shown to the right in broken line form. During the return travel to the starting position the back pressure cylinder 108 is raised somewhat, so that the return of the tool carrier device can take place without contact with the embossing foil web or the back pressure cylinder.

As is intimated to the left in FIG. 1, the foil feed device 140 can guide in parallel several juxtaposed embossing foil webs 130, 130′, e.g. 2 or 3 or 4 or 5 or 6. The foil feed device 140 makes it possible to move the embossing foil web outside the embossing interval more slowly than the material layer to be embossed and to accelerate it upstream of the embossing interval to the material layer speed and then decelerate it again and retract it in a withdrawal phase counter to the main feed direction 149. As a result of the discontinuous foil web movement with drawal phases it is possible to place the transferred embossing units or ink layer areas in directly succeeding manner on the embossing foil web, even if the embossing locations on the printing material are much further apart.

Each embossing foil web is guided from a left-hand storage roll 141, 141′ through a foil loop storage means 142 by means of a suction roller 143 rotating counter to the main feed direction and passive deflecting means (e.g. air bars or blast pipes and/or deflector rollers) in the direction of the embossing gap 110 and from there by means of several passive deflecting means (e.g. air bars or blast pipes and/or deflector rollers) to a so-called timing roller or control roller 145, which within the foil feed direction system represents the “zero point” of the foil web movement. Starting from an upstream deflector roller or bar, the foil web is guided from there over a relatively large looping angle of e.g. between 130 and 180ø over the timing roller circumference towards the downstream disposal device 150. The timing or control rollers 145 are controllable with the aid of suitable electromotive drives with regards to the rotation direction and rotation speed, i.e. are suitable for a forward-return operation and belong to the control-active control devices of the foil mechanism. In exemplified manner they are constructed as low-weight suction rollers and have in each case an area looped by the foil web and provided with perforations by means of which and a suction blower a vacuum can be produced which draws the looping foil web portion reliably onto the suction roller circumference, so that it is possible to ensure rolling contact with static friction, but without any slip. Alternatively or additionally to suction the slip-free rolling contact can be ensured by means of pressure rollers, inflation, etc. The control rollers 145 positioned downstream of the embossing gap cooperate with the suction roller 143 at the outlet of the foil loop storage means 142 rotating continuously counter to the main feed direction, so as to ensure in the intermediate useful area 148 an adequate web tension and in order to precisely control the foil web speed and direction. For this purpose the suction roller 143 positioned upstream of the embossing gap is operated as a tension or pull device with slip drive, which exerts on the at least one embossing foil web guided above the same and in continuous manner a tension in the direction of the foil loop storage means 142, i.e. counter to the main feed direction 149. The tension is large enough in order to ensure the web tension in the embossing gap and bring about a return feed of the embossing foil web if the control or timing rollers 145 are rotated counterclockwise, i.e. in the return feed direction. The tension produced by the slip drive 143 is not, however, sufficient in order to overcome the static friction built up between the embossing foil web and the timing roller circumference, so that the web position of the embossing foil web and its web speed is exclusively precisely defined by the rotation position and speed of the suction roller 145.

Thus, on operating the apparatus, as a result of the cooperation of the timing rollers 145 downstream of the embossing gap and the slip drive 143 upstream of the embossing gap the above-described continuous movement of the embossing foil web with drawal phases through the embossing gap is brought about. As simultaneously the unused embossing foil web is supplied by the continuously rotating storage rolls 141, 141′, there is a change to the level of filling of the vacuum foil loop storage means 142, which partly empties in the acceleration phases with rapid embossing foil web advance and fills in deceleration phases and withdrawal phases of the embossing foil web. Thus, the foil loop storage means uncouples the side of the continuous foil entry from the area of the discontinuous foil web movement between slip drive 143 and the non-slip control rollers 145.

Particularly in the case of embossing apparatuses with discontinuous foil advance and optionally foil retraction, the disposal of used embossing foil webs is of vital significance, because this is to be performed in such a way that the disposal does not lead to machine stoppage times and so that the disposal means have no reaction on the precisely controlled foil feed through the embossing gap. Therefore the disposal device 150 comprises a tension or pull conveying device 160 directly downstream of the timing rollers 145 and which removes the at least one embossing foil web from the last control device 145 of the foil feed device 140 positioned upstream thereof and a cutting device 170 positioned downstream of the tension conveying device 160 and which every so often cuts through the embossing foil web or webs passing out from the tension conveying device, so that embossing foil web portions of suitable length are obtained and can subsequently be easily disposed of.

The tension conveying device has an entry side facing the foil mechanism 140 and an exit side facing the cutting device 170, together with an intermediate, in the exemplified case linear engagement area 161, in which it acts on the embossing foil web passed through in the sense that on said web there is a tension drawing it away from the timing rollers and which independently of the embossing foil web speed direction and value always acts in the same tension direction 165, namely away from the timing rollers. As a result the used embossing foil webs are held in orderly, tensioned manner outside the controlled movement in useful area 148, i.e. downstream of the timing rollers 145 and can be conveyed away by the foil feed device. The tension acts uninterruptedly or continuously and is lower than the forces which would be needed in order to draw off the embossing foil web from the circumference of the suction rollers 145, whilst overcoming the static friction. Thus, the control rollers 145 effectively protect the critical useful area 148 of the embossing foil web movement through the embossing gap from reactions from the area of the disposal device 150. The length of the engagement area 161 in the web direction is in this embodiment larger than the maximum withdrawal or retraction distance by which the embossing foil web is retracted during embossing apparatus operation. As a result the free end of an embossing foil web following the cutting through of an embossing foil web portion is not extracted from the tension conveying device during a subsequent retraction movement so as to be disengaged from said tension conveying device. Typical lengths of the engagement area can e.g. be at least 20, or 30 or 40 or 50 or more centimetres.

If in the operation of the apparatus through the intermittent advance in the main feed direction 149 an adequate used embossing foil web length has been conveyed through the tension conveying device, the cutting device 170 is activated and cuts through the embossing foil web portion. It can be subsequently conveyed e.g. by a suction device 180 in the direction of a shredder 190 or a baling press or some other disposal unit for foil web portions.

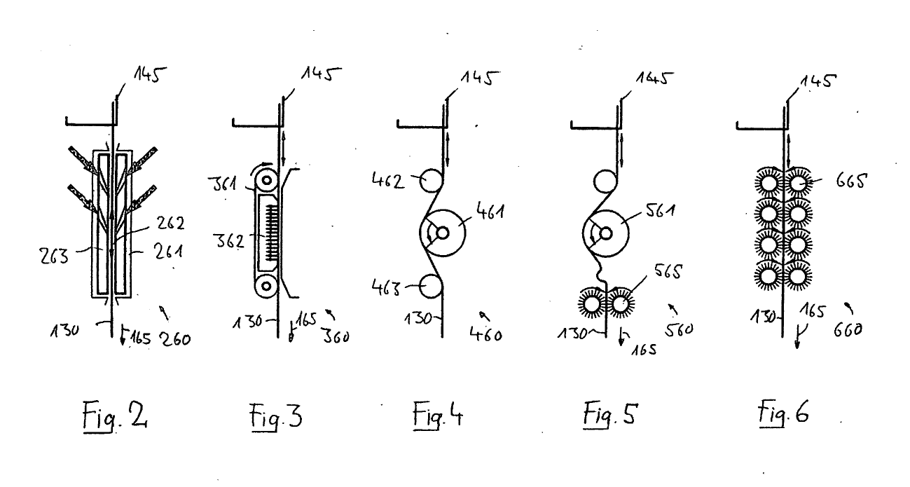

There are numerous tension conveying device design possibilities. The tension conveying device 260 of FIG. 2 is designed as a contactless operating, pneumatic device (air conveyor) without movable elements, in which the embossing foil web 130 is conveyed exclusively by means of a directional air flow in tension direction 165. In a flat, rectangular housing 261 of air conveyor 260 is formed a flat conveying channel 262, in which are fitted in juxtaposed manner several embossing foil webs, e.g. two, three, four, five, six or more such webs. The conveying channel 262 has a width measured perpendicular to the web passage plane between one and a few centimetres and is bounded on either side by flat nozzle elements 263 bounded by sloping air passage openings and which when subject to compressed air action produce air flows directed obliquely in the conveying direction and which act on either side, i.e. on the front and rear sides of the embossing foil web. In the case of a suitable control, the embossing foil webs can be conveyed between largely eddy-free air flows in tension direction 165 without the embossing foil webs coming into contact with elements of the tension conveying device. The pneumatically applied tensions ensure an orderly guidance of the conveyed foil web portions and simultaneously the tensions applied are so low that there is no reaction on the foil web movement through the embossing gap.

FIG. 3 shows a tension conveying device 360 with slip drive, which has a revolving, perforated conveyor belt 361 with an integrated suction box 362. Through the conveyor belt holes the suction box produces a suction force on the embossing foil web, as a result of which said web is continuously pressed onto the conveying surface of the conveyor belt moved in the tension direction. In each phase of the operation the conveyor belt has a speed excess compared with the embossing foil web, so that the latter is in the case of said device conveyed by means of sliding friction which acts over a relatively large, planar conveying surface.

FIG. 4 shows another variant of a tension conveying device 460 with slip drive. In this case a suction roller 461 is provided and is so located between two deflector rollers 462, 463, that the at least one embossing foil web over a looping angle of approximately 90ø is led past the cylindrically curved suction roller circumference into a suction-active area, in which the embossing foil web is sucked onto the circumference of the rotating suction roller. Here again there is constantly a speed excess of the suction roller compared with the embossing foil web, so that exclusively sliding friction arises, so that a continuously gentle tension is exerted on the embossing foil web, no matter whether it is moved in the direction of the downstream cutting device or, in a withdrawal phase, in the direction of the foil feed device.

The tension conveying device 560 in FIG. 5 is a variant of that shown in FIG. 4 and has a suction roller 561 and deflecting devices arranged on either side, the downstream deflecting device being formed by a pair of oppositely rotating conveying brushes 561, which actively contribute to the foil feed in tension direction 165. In order to avoid foil folds, the conveying brushes rotate with a speed excess compared with the embossing foil webs and also the suction roller 561.

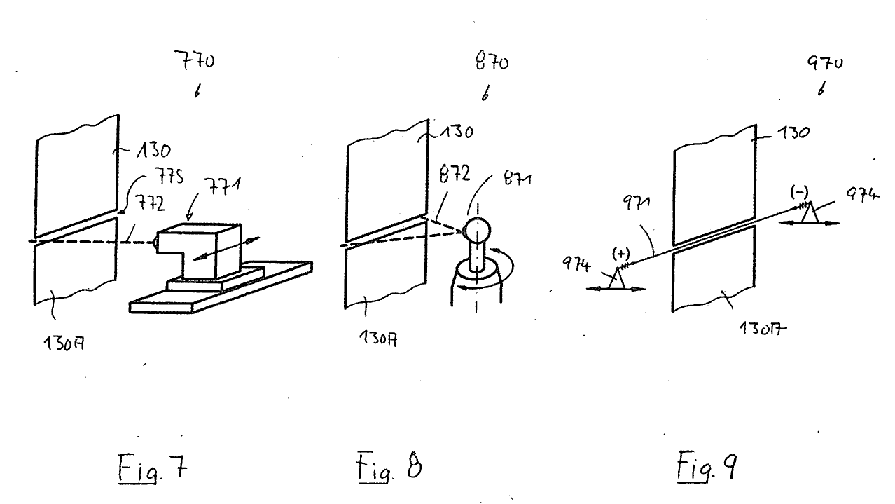

The tension conveying device 660 in FIG. 6 is designed purely as a brush conveyor and comprises four pairs of in each case oppositely rotating conveying brushes 665, which overall form a linear conveying path for each passed through embossing foil web. The relatively long bristle conveying brushes exert a continuous, gentle tension on the embossing foil web acting in the direction of the downstream cutting device. However, they also allow a retraction of the embossing foil web counter to the tension direction 165.

FIGS. 7 to 9 show examples of embodiments of cutting devices, which cut through the embossing foil web or webs after passing out of the engagement area of the upstream tension conveying device in certain time intervals transversely to the embossing foil web longitudinal direction. In the case of the cutting device 770 in FIG. 7 use is made of a laser 771 movable linearly transversely to the foil web feed direction and which emits a laser beam 772, whose radiation energy is sufficient for melting the substantially plastic embossing foil web and consequently cutting along a cutting line 775 running transversely to the web direction. In each case several parallel embossing foil webs can be cut through in a single cutting step. As this thermal cutting device operates in contactless manner, no mechanical forces are exerted on the embossing foil web, so that a reaction of the cutting process on the foil feed through the embossing gap is excluded.

The time sections between the cutting processes can be predetermined by a suitable programming, but it is also possible to control the timing of the cutting processes on the basis of measurements of the embossing foil web length which has passed through. In each case embossing foil web portions 130A of a clearly defined length are obtained and can subsequently be easily disposed of.

The cutting device 870 in FIG. 8 has a hot air blower, which by means of a nozzle tip or head 871 pivotable about a vertical axis delivers a finely focussed hot air jet 872, which during the pivoting of the nozzle head passes transversely over the embossing foil web and causes melting along the resulting cutting line, so that a cut through embossing foil web portion 130A is obtained. Also in this contactless operating variant there can be no reaction on the foil feed in the foil mechanism.

Alternatively the hot air blower can be linearly displaceable transversely to the web direction, in the same way as laser 771. Laser 771 can alternatively be pivotable, e.g. similar to what is shown for the hot air blower.

The thermal device 970 in FIG. 9 has an electrically heatable heating wire 971, which is so fixed between two synchronously parallel and linearly movable bearing points 974 that it runs transversely to the embossing foil web longitudinal direction and can be essentially moved in a direction perpendicular to the foil web surface. For cutting through one or more embossing foil webs, the heating wire is briefly brought over its entire length onto the passing through embossing foil web and melts the same during the brief contact along the entire cutting line, which gives rise to a cut off embossing foil web portion 130A. This variant operating with contact also gives rise to no forces acting in the foil web direction.

Each of the tension conveying devices shown in FIGS. 2 to 6 can be combined with each of the cutting devices shown in FIGS. 7 to 9, the cutting devices in each case being positioned in preferred manner directly behind the corresponding tension conveying devices, i.e. without an interposed deflection, although this can be provided. If e.g. the contactless operating, pneumatic tension conveying device 260 is combined with the laser cutting device 770 or hot gas cutting device 870, then neither for the tension conveying, nor for the cutting through is it necessary to have contact with the embossing foil web, so that disposal has no negative reaction on the foil feed.

The presently described method and the associated devices for treatment of the embossing foil webs downstream of the last active control device of the foil mechanism can be used in differently built up embossing machines. For example the embossing machine can be in the form of a pure rotary machine (round-round machine). The disposal devices can also cooperate with differently constructed foil feed devices. The foil mechanism can e.g. be built up in the manner shown in EP 718 099 B1, namely with a tension device having slip drive downstream of the embossing gap and a controllable foil supply device upstream of said embossing gap and cooperating with the tension device. Thus, it would e.g. be possible to interchange the position of the suction roller 143 acting as the tension device with slip drive and that of the timing rollers 145 relative to the embossing gap and then the tension device with slip drive would permanently exert a tension towards the disposal device.

The invention can be used with different hot embossing or hot stamping variants, as well as for different cold embossing or cold stamping procedures.

What is claimed is:

1. A method for disposing of used embossing foil web during the operation of an embossing apparatus, in which method at least one embossing foil web is moved with the aid of a foil feed device with varying web speed through an embossing gap and is then supplied to a disposal device, the method comprising:
removing the embossing foil web from a final control device of the foil feed device by means of a tension conveying device positioned downstream of the foil feed device, wherein the tension conveying device produces a tension acting on the embossing foil web in the same tension direction independently of the direction and value of the embossing foil web speed;
cutting through the embossing foil web in predeterminable time sections downstream of the tension conveying device outside an engagement area of said tension conveying device for producing cut off embossing foil web portions; and
disposing of the cut off embossing foil web portions.

2. The method according to claim 1, wherein the tension of the tension conveying device at all times is lower than the tensions acting on the embossing foil web within the foil feed direction.

3. The method according to claim 1, wherein the embossing foil web is retracted by a given retraction distance in phasewise manner counter to the tension applied by the tension conveying device

4. The method according to claim 3, wherein an amount of a maximum retraction distance of the embossing foil web in operation is smaller than the length of the engagement area of the tension conveying device.

5. The method according claim 1, wherein the embossing foil web is conveyed in the tension direction in substantially contactless manner within the tension conveying device.

6. The method according claim 5, wherein the embossing foil web is conveyed in the tension direction by means of a directional gas flow.

7. The method according to claim 1, wherein the embossing foil web is pressed in the tension conveying device onto a conveying surface moved in the tension direction.

8. The method according to claim 7, wherein the conveying surface of the tension conveying device moves continuously with a speed excess compared with the embossing foil web in the tension direction.

9. The method according to claim 1, wherein the tension conveying device contains at least one conveying brush engaging on the embossing foil web and whose bristles, on rotating the conveying brush, transfer a contribution to the tension on the embossing foil web, wherein end portions of the bristles acting on the embossing foil web move continuously with a speed excess compared with the embossing foil web in the tension direction.

10. The method according to claim 1, wherein the embossing foil web is melted with the aid of a locally concentrated thermal action for cutting through purposes along a cutting line running transversely to the web direction.

11. The method according to claim 1, wherein the embossing foil web is cut through in contactless manner.

12. The method according to claim 1, wherein for cutting through the embossing foil web use is made of a laser.

13. The method according to claim 12, wherein a beam of the laser is guided by at least one of a movement of the laser and a movable deflection in the manner of a scanner along the cutting line.

14. The method according to claim 1, wherein use is made of a jet mechanism for cutting through the embossing foil web.

15. The method according to claim 14, wherein the jet mechanism includes a hot gas jet device.

16. The method according to claim 10, wherein the embossing foil web is cut through by means of a heatable heating wire.

17. An embossing apparatus comprising:
an embossing mechanism where at least temporarily an embossing gap is formed between an embossing tool carrier device and a back pressure element;
a foil feed device for feeding at least one embossing foil web through the embossing gap with varying web speed; and
a disposal device for disposing of used embossing foil webs positioned downstream of the foil feed device, the disposal device comprising:
a tension conveying device downstream of the foil feed device for removing at least one embossing foil web from a final control device of the foil feed device; and
a cutting device downstream of the tension conveying device for cutting through the embossing foil web in predeterminable time sections outside an engagement area of the tension conveying device.

18. The embossing apparatus according to claim 17, wherein the foil feed device contains active control devices set up to retract the embossing foil web phasewise and counter to the tension applied by the tension conveying device by a retraction distance

19. The embossing apparatus according to claim 18, wherein an amount of a maximum retraction distance is smaller than a length of the engagement area of the tension conveying device.

20. The embossing apparatus according to claim 18, wherein the last control device of the foil feed device has a control roller controllable with respect to the rotation direction and rotation speed

21. The embossing apparatus according to claim 20, wherein the controller roller is constructed as a suction roller.

22. The embossing apparatus according to claim 18, wherein the tension conveying device is constructed as a substantially contactless operating tension conveying device,

23. The embossing apparatus according to claim 22, wherein the tension conveying device is a pneumatic tension conveying device for producing a directional gas flow acting on the embossing foil web.

24. The embossing apparatus according to claim 18, wherein the tension conveying device contains at least one conveyor element with a conveying surface moving in the tension direction onto which the embossing foil web is pressed.

25. The embossing apparatus according to claim 24, wherein the embossing foil web is pressed onto the conveying surface by suction.

26. The embossing apparatus according to claim 18, wherein the tension conveying device contains at least one rotary conveying brush, whose bristles, on rotating said conveying brush, transfer a contribution to the tension onto the embossing foil web,

27. The embossing apparatus according to claim 26, wherein the tension conveying device contains at least one pair of oppositely rotatable conveying rollers, between which at least one embossing foil web is passed during operation of the embossing machine.

28. The embossing apparatus according to claim 18, wherein a contactless operating cutting device is provided.

29. The embossing apparatus according to claims 18, wherein a thermally operating cutting device is provided, which is set up in such a way that the embossing foil web is melted with the aid of a locally concentrated thermal action along a cutting line running transversely to the web direction.

30. The embossing apparatus according to claim 18, wherein the cutting device contains a laser.

31. The embossing apparatus according to claim 30, wherein a laser beam of the laser is guided along a cutting line by at least one of a movement of the laser and a movable deflection in the manner of a scanner.

32. The embossing apparatus according to claim 29, wherein the cutting device has a hot gas jet device.

33. The embossing apparatus according to claim 29, wherein the cutting device has a heatable heating wire.

34. A disposal device for disposing of used embossing foil webs passing out of a foil feed device downstream of a final control device of the foil feed device, comprising:
a tension conveying device configured to be positioned downstream of the final control device of a foil feed device for removing at least one embossing foil web from the final control device of the foil feed device; and
a cutting device arranged downstream of the tension conveying device for cutting through the embossing foil web in predeterminable time sections outside an engagement area of the tension conveying device.

35. The disposal device according to claim 34, wherein the cutting device contains a laser.
